(19) United States
(12) Patent Application Publication
(10) Pub. No.: US 2005/0156818 A1
(43) Pub. Date: Jul. 21, 2005

(54) On-screen display device

(75) Inventor: Yoshiyuki Tsuji, Takefu-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Takefu-city (JP)

(21) Appl. No.: 11/028,560

(22) Filed: Jan. 5, 2005

(30) Foreign Application Priority Data
Jan. 7, 2004 (JP) 2004-001680

(51) Int. Cl. G09G 1/14

(52) U.S. Cl. 345/26

(57) ABSTRACT

The present invention provides an on-screen display device capable of freely changing a display position, coloration of a display color, and brightness level and moving the display position simply and speedily. When a clock and channel are displayed on-screen and superimposed on an image signal, it is possible to receive a remote control signal from a remote control device 9 and arbitrarily change the display position, display color, and brightness through an OSD position control section 2, OSD color control section 3, and OSD brightness control section 4 of a microcomputer 1. This makes it possible to display the display position of the clock or channel, etc., at an optimum position easily viewable to a user and adjust the display color and brightness in an easily viewable manner. When changing the display position, the display position of a character is moved to an area of a screen 20 assigned to a number key beforehand by operating number keys of the remote control device 9. Hereafter, by adjusting the display position using up/down keys and cursor keys of the remote control device, it is possible to change the display position of the character in a short time.

The present application is based on and claims priority of Japanese patent applications No. 2004-001680 filed on Jan. 7, 2004, the entire contents of which are hereby incorporated by reference.

### BACKGROUND OF THE INVENTION

1. Field of the Invention

The present invention relates to an on-screen display device which displays on-screen a character signal such as number, character or symbol superimposed on an image signal on a screen.

2. Description of the Related Art

An on-screen function is conventionally available as a function of a television receiver or image storage/reproduction device. This function is intended to display a character signal such as character or symbol superimposed on an original image signal.

However, since a character displayed on a screen is superimposed on an image, it is sometimes difficult to see the character depending on the background image. Therefore, for example, Japanese Patent Laid-Open Publication No. 8-149388 (Patent Document 1) discloses an on-screen display device capable of moving an entire character superimposed on the screen in horizontal direction on the screen using display position moving means so as to adjust the position of the character to an easily viewable position. Furthermore, Japanese Patent Laid-Open Publication No. 7-162750 (Patent Document 2) discloses an on-screen control device which makes it possible to arbitrarily change the size and position of a character superimposed on an image signal through key operations from a remote control device, or the like. Furthermore, when an image signal and a character have similar coloration, a background image and the character interfere with each other, which makes it difficult to read the character, and therefore Japanese Patent Laid-Open Publication No. 7-322094 (Patent Document 3) discloses a display device which displays a color of a color code corresponding to an address on a display and makes it possible to rewrite a set value of this register and thereby change the display color of a character signal superimposed on the screen to arbitrary coloration. Japanese Patent Laid-Open Publication No. 6-208367 (Patent Document 4) discloses an image display device which makes the display of a character signal darker when image information is adjusted or changes character information in accordance with the display condition of the image information to thereby enable to change the brightness level of the character signal.

Thus, the image display devices in Patent Document 1 and Patent Document 2 can move the display position of a character to an easily viewable position, but cannot change the display color and brightness. Furthermore, the image display devices in Patent Document 3 and Patent Document 4 can change the display color or brightness of a character but cannot change the display position of a character or number superimposed on an image. Moreover, even when the display position of a character such as character or number is changed to a position easily viewable to a user, a background image and character or number may have colors of the same tone depending on the image of the display position, which makes the character or number hardly legible. Furthermore, the display position of a character superimposed on an image is normally changed using keys provided for a television receiver or image storage/reproduction device or a cross key, etc., of a remote control device attached thereto, however, when the display position of the character signal is moved on a relatively large scale, the key is depressed continuously until the character signal is completely moved to a desired position, which increases the operation time and degrades the operability.

The present invention has been implemented in view of the above described problems, and it aims at providing an on-screen display device capable of freely changing the display position of a character or number superimposed on an image and the coloration of the display color and brightness level, making the superimposed character or number easily legible, and moving the display position of the character or number simply and speedily.

### BRIEF SUMMARY OF THE INVENTION

The on-screen display device provides as a first aspect of the present invention an on-screen display device which displays on-screen a character signal such as a number, character or symbol superimposed on an image signal, comprising display position control means for moving the display position of a character displayed on the screen to an arbitrary position and display color control means for changing the display color of the character.

This arrangement allows the position control means to change the position of the on-screen display to an optimum position for a user and allows the display color control means to change the display color of the on-screen display appropriately so as to adjust the display colors of a background image and colors displayed on on-screen so that they do not interfere with each other.

The on-screen display device provides as a second aspect of the present invention the on-screen display device according to the first aspect of the invention, further comprising brightness control means for changing the brightness level of the character displayed on the screen.

This arrangement allows the brightness control means to change the brightness of the on-screen display appropriately so as to adjust the on-screen display in a more easily viewable manner against a background image.

The on-screen display device provides as a third aspect of the present invention the on-screen display device according to the first and second aspect of the invention, further comprising a remote control device which displays a selection menu on the screen when the display state of the character displayed on the screen is changed and outputs a remote control signal related to this selection operation, discrimination means for discriminating a transmission signal from this remote control device, and instruction means for receiving the transmission signal from this discrimination means and outputting a selection signal to the respective control means.

According to this arrangement, when the remote control device operates changes in the display position of the on-screen display and brightness of the display color, the discrimination means receives the transmission signal from the remote control device, and then, the instruction means outputs a selection signal to the position control means, display color display means, and brightness control means corresponding to their respective adjustment items. The on-screen display is performed with the display position, display color, and brightness set by the user according to the data of the respective control sections.

The on-screen display device provides as a fourth aspect of the present invention the on-screen display device according to the third aspect of the invention, wherein the remote control device comprises key input means including a menu key and menu selection key for executing various adjustments/settings of electric apparatus, a plurality of number keys assigned so as to move the character to each of the plurality of areas preset on the screen when the display position of the character displayed on the screen is changed and an adjustment operation key which adjusts the display position moved by this number keys from right to left or up and down so as to move the display position to an arbitrary position.

According to this arrangement, when the display position is changed, operation of the number keys corresponding to the area causes the display position to be displayed in the corresponding area. Adjusting the display position using the adjustment operation key thereafter allows the display position to be changed to an arbitrary position.

The on-screen display device according to the first aspect of the present invention is the on-screen display device which displays on-screen a character signal such as number, character or symbol superimposed on an image signal comprising display position control means for moving the display position of the character displayed on the screen to an arbitrary position and display color control means for changing the display color of the character, and therefore makes it possible to change the position of the on-screen displayed character to an optimum position for the user and adjust the on-screen-displayed character against a background image in an easily viewable manner.

The on-screen display device according to the second aspect of the present invention is the on-screen display device according to the first aspect of the invention comprising brightness control means for changing the brightness level of the character displayed on the screen, and therefore makes it possible to adjust the character against the background image in an easily viewable manner.

The on-screen display device according to the third aspect of the present invention is the on-screen display device according to the first and second aspect of the invention, further comprising a remote control device which displays a selection menu on the screen when the display state of the character displayed on the screen is changed and outputs a remote control signal related to this selection operation, discrimination means for discriminating a transmission signal from this remote control device and instruction means for receiving the transmission signal from this discrimination means and outputting a selection signal to the respective control means, and therefore makes it possible to easily change the display position, display color, and brightness of the on-screen display using the remote control device.

The on-screen display device according to the fourth aspect of the present invention is the on-screen display device according to the third aspect of the invention, wherein the remote control device comprises the key input means including a menu key and menu selection key for executing various adjustments/settings of electric apparatus, a plurality of number keys assigned so as to move the character to each of the plurality of areas preset on the screen when the display position of the character displayed on the screen is changed and an adjustment operation key which adjusts the display position moved by this number keys from right to left or up and down so as to move the display position to an arbitrary position, and therefore makes it possible to display, when changing the display position, the display position in the corresponding area by operating the number keys corresponding to the area, change the display position to an arbitrary position by adjusting the display position using the adjustment operation key thereafter and thereby shorten the operation time when the display position of the character is drastically moved and simplify the movement operation.

### BRIEF DESCRIPTION OF THE DRAWINGS

FIG. 1 is a block diagram of an on-screen device according to an embodiment of the present invention;

FIG. 2 is a front view of a remote control transmitter according to an embodiment of the present invention;

FIG. 3 illustrates an on-screen menu according to an embodiment of the present invention;

FIG. 4 illustrates an OSD display setting screen according to an embodiment of the present invention;

FIG. 5 illustrates an adjustment item selection screen according to an embodiment of the present invention;

FIG. 6 illustrates a show/hide selection screen according to an embodiment of the present invention;

FIG. 7 illustrates a state when “hide” is selected according to an embodiment of the present invention;

FIG. 8 illustrates a state in which a display color and brightness are selected according to an embodiment of the present invention;

FIG. 9 illustrates a display color selection screen according to an embodiment of the present invention;

FIG. 10 illustrates a display position selection screen according to an embodiment of the present invention; and

FIG. 11 illustrates a display position setting state using number keys according to an embodiment of the present invention.

### DETAILED DESCRIPTION OF THE PREFERRED EMBODIMENTS

Now, with reference to the attached drawings, preferred embodiments of the present invention will be explained.

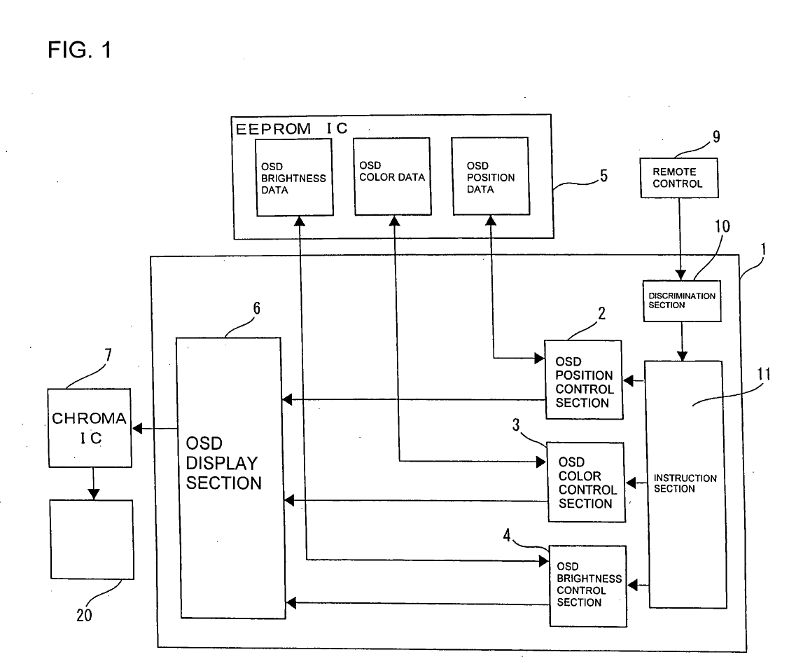

FIG. 1 is a block diagram of an embodiment of the present invention. In FIG. 1, reference numeral 1 denotes a microcomputer which controls an on-screen display device which displays on-screen a character signal such as a number, character or symbol superimposed on an image signal on a screen 20 of a CRT or LCD, etc. This microcomputer 1 is provided with an on-screen display (hereinafter referred to as “OSD”) position control section 2 as display position control means for moving the position of a character signal to an arbitrary position on the screen 20, an OSD color control section 3 as display color control means for changing the character display color to arbitrary coloration individually, and an OSD brightness control section 4 as brightness control means for changing the brightness level of the character. The data of these OSD position control section 2, OSD color control section 3, and OSD brightness control section 4 is stored in a memory 5 such as a rewritable EPPROM, the data stored in the memory 5 is fed back to the respective control sections 2 to 4 and an OSD display section 6 generates a character signal such as a number and character according to the data of the respective control sections 2 to 4. This character signal is output to an image signal processing circuit 7 such as CHROMAIC, superimposed on the image signal generated by the image signal processing circuit 7 and the character signal is on-screen displayed on the display screen 20. Furthermore, the microcomputer 1 is provided with discrimination means 10 for receiving a transmission signal from a remote control device 9 and discriminating a remote control signal from the remote control device 9, and instruction means 11 for outputting the selection signal of the remote control device 9 output from the discrimination means 10 to the OSD position control section 2, OSD color control section 3 and OSD brightness control section 4.

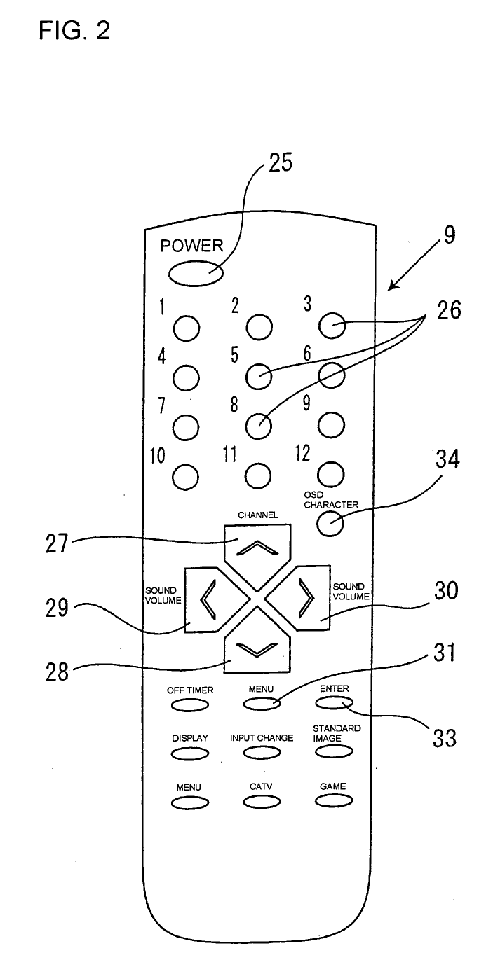

The remote control device 9 operates a television receiver and image storage/reproduction device and performs a channel selection and input switching, etc., through key inputs and various adjustments and settings of the television receiver or image storage/reproduction device receiver. Furthermore, these various adjustment and setting items are displayed in a menu on the screen 20 and the user can select a desired item while watching the menu screen and perform various adjustments and settings and as shown in FIG. 2, the remote control device 9 is provided with, for example, a power key 25 which supplies power to the main unit of the television receiver, channel selection number keys 26, a pair of up/down keys 27, 28 for selecting a channel above or below and selecting a predetermined adjustment/setting from the menu displayed, a pair of right/left cursor keys 29, 30 for adjusting a sound volume, a menu key 31 for displaying a menu screen and an enter key 33, and an OSD character key 34 for displaying various on-screen selection items, etc. Here, the frequently used up/down keys 27, 28 and cursor keys 29, 30 are arranged substantially in the center of the remote control device 9 in a cross shape as adjustment operation keys.

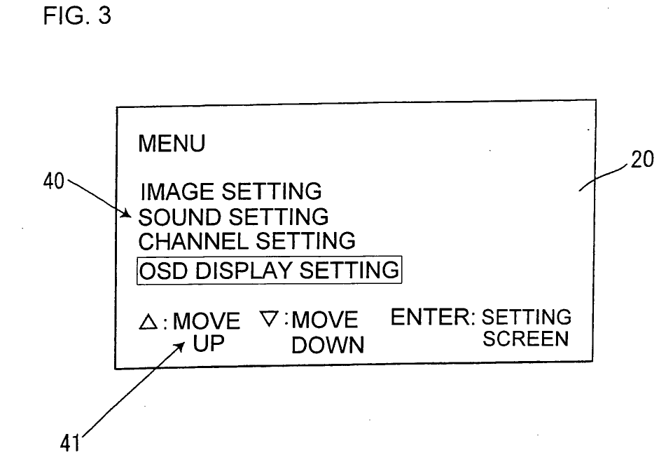

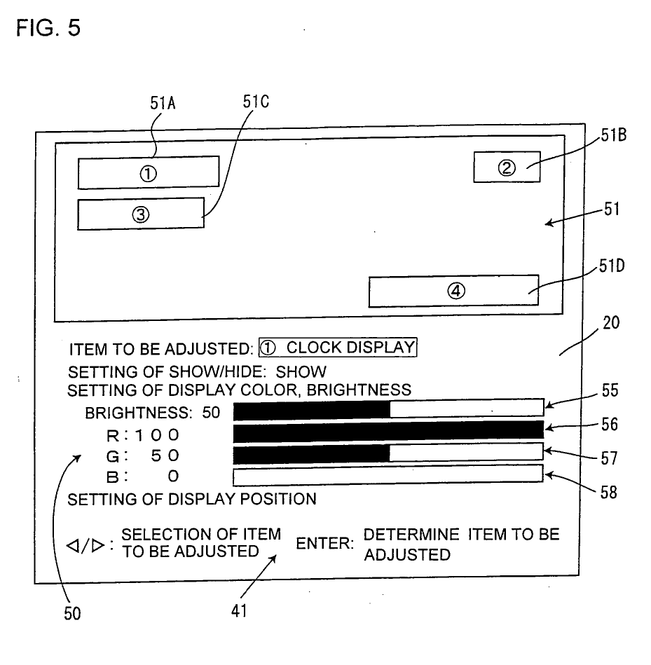

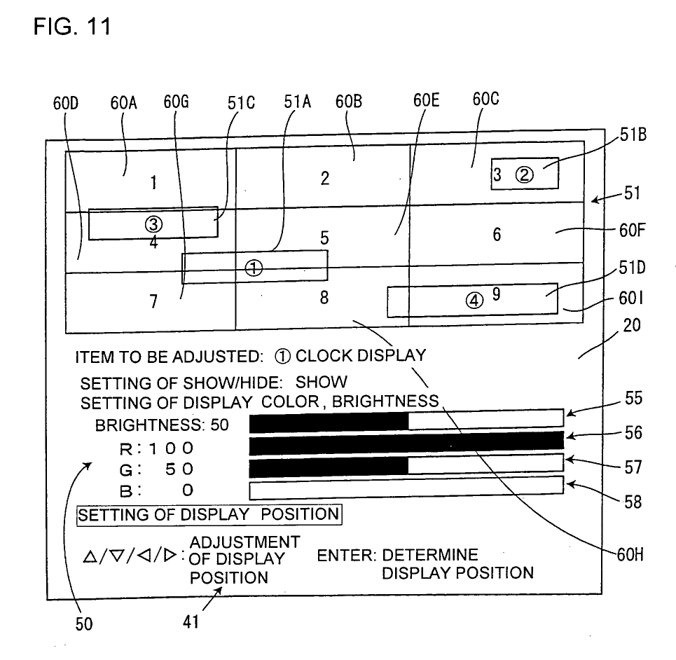

Next, with reference to FIG. 3 through FIG. 11, the on-screen menu operation device of the present invention will be explained. FIG. 3 shows an example of the menu screen displayed when the menu key 31 is operated. When the menu key 31 is operated, the screen 20 shows operation items like “image setting”, “sound setting”, “channel setting”, and “OSD display setting” as an operation menu 40 and a guide display 41 which guides an operation method below the display menu 40. The background of the selected item is changed so that the selected item can be distinguished from other items and thereby recognized by the user and FIG. 3 shows a state in which the OSD display setting is selected.

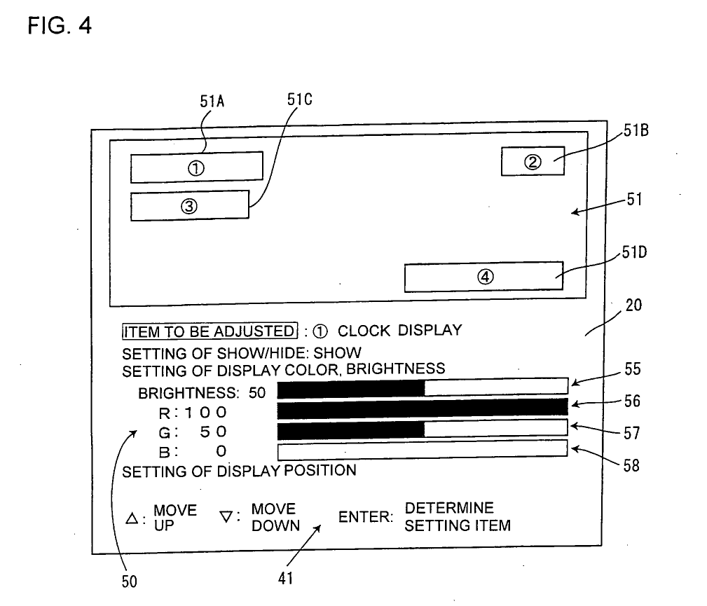

Here, when the user operates the up/down keys 27, 28, the selected item moves up and down one by one when the “OSD display setting” is selected and by operating the enter key 33, the screen shows an OSD menu screen as shown in FIG. 4. It is also possible to operate the OSD character key 34 of the remote control device 9 to move to the OSD selection menu.

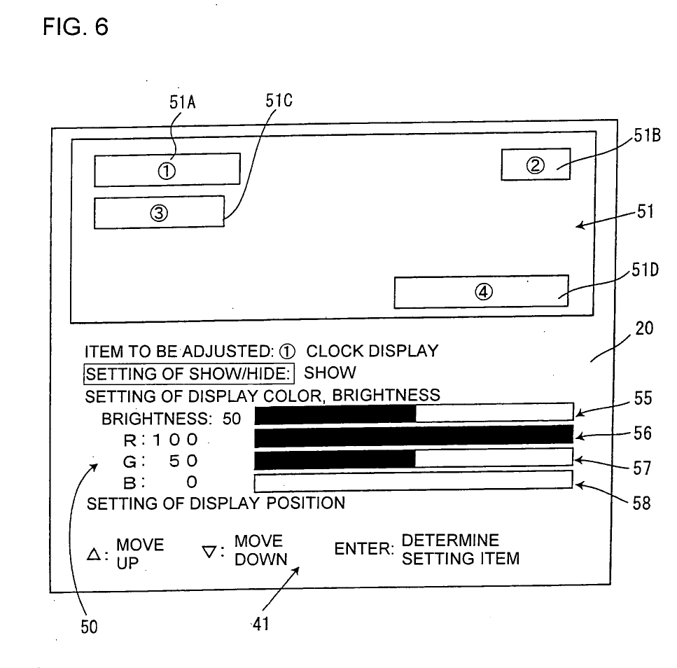

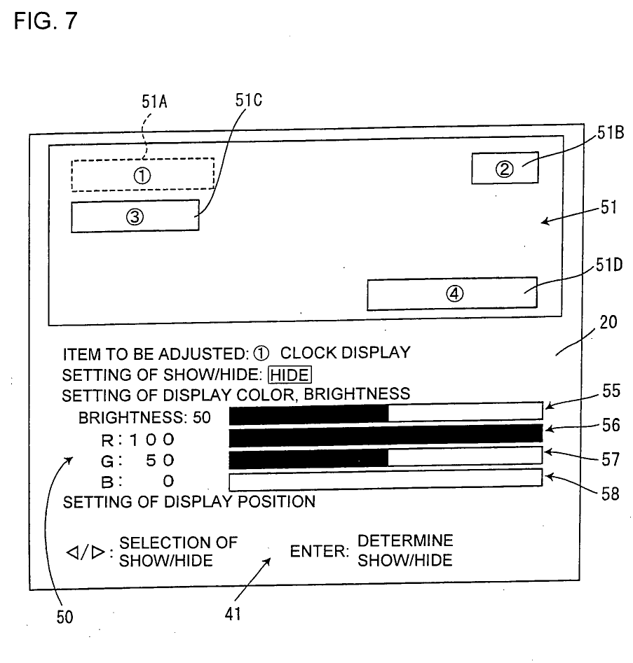

The OSD selection menu shows on the screen 20, “item to be adjusted”, “setting of show/hide”, “setting of display color, brightness”, and “setting of display position” as an operation menu 50, and shows thereabove an OSD display 51 which corresponds to each adjustment item and shows a guide display 41 which guides the operation method below the display menu 40. The OSD display 51 shows a clock display 51A at the top left side of the screen 20, a channel display section 51B at the top right side of the screen 20, an operation display 51C showing operation such as play, stop, fast-forward of the deck below the clock display 51A, and a deck counter display 51D at the bottom right side of the screen 20, and various types of information corresponding to this position are displayed on-screen on the screen 20. These displays 51A to 51D are numbered as follows; 1 for the clock display 51A, 2 for the channel display section 51B, 3 for the operation display 51C, and 4 for the counter display 51D. Furthermore, on the OSD menu screen, a guide display 41 which guides the operation method is also displayed below the operation menu 50. Settings on the displays 51A to 51D shown on the screen 20 are performed with this OSD selection menu. First, the cursor is placed on “item to be adjusted” using the up/down keys 27, 28 and then, the enter key 33 is operated, and at last, an item to be set is selected. When an item is selected, the background of the item on which the cursor is placed changes, making the selected item visually distinguishable. After the “item to be adjusted” is selected, the cursor is moved to on-screen displayed “clock display”, “channel display section”, “operation display”, and “counter display” using the cursor keys 29, 30, making it possible to set an item to be selected. Here, since the “clock display”, “channel display section”, “operation display” and “counter display” are numbered 1 to 4, it is also possible to directly specify the item selected by the number keys 26. That is, it is possible to set “clock display” using the number key 26 of “1”, “channel display section” using-the number key 26 of “2”, “operation display” using the number key 26 of “3” and “counter display” using the number key 26 of “4”. Thus, any one of “clock display”, “channel display section”, “operation display”, and “counter display” is selected (FIG. 4 shows a state in which “clock display” is selected) and then the enter key 33 is operated and the setting item of the selected display is set. The setting items include “show/hide on-screen”, “brightness”, “display color”, and “display position”. To set “show/hide on-screen”, as shown in FIG. 6, the cursor is first placed on the item “show/hide” using the up/down keys 27, 28, and then, the item is determined using the enter key 33, and at last, as shown in FIG. 7, either “show” or “hide” is selected by the cursor keys 29, 30. FIG. 7 shows a state in which “hide” is selected and when “hide” is selected, the outline of the corresponding part in the OSD display 51 (clock display 51A in FIG. 7) becomes thinner.

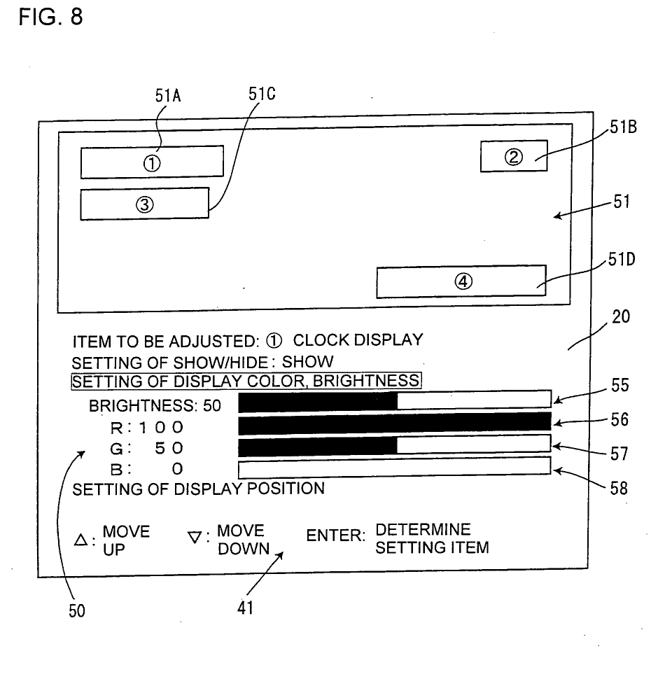

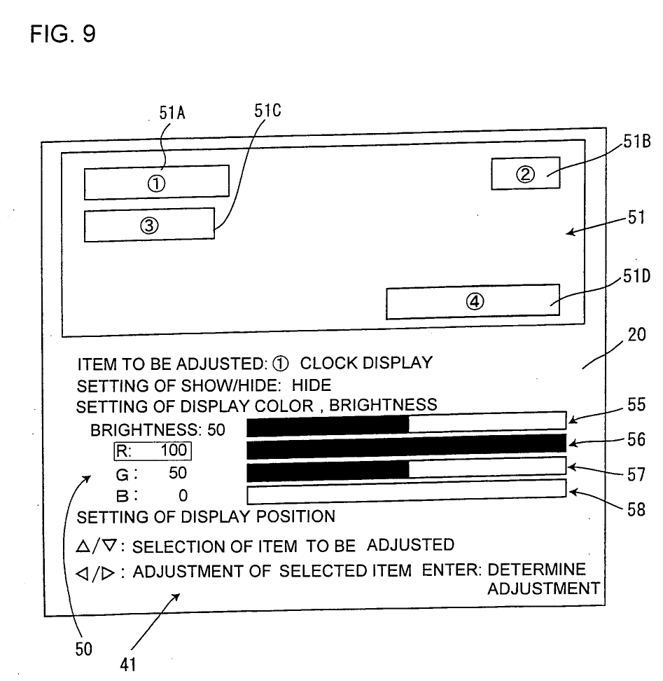

To set the display color and brightness of the on-screen display, as shown in FIG. 8, the cursor is placed on “setting of display color, brightness” using the up/down keys 27, 28, the item is determined by the enter key 33, and then, the cursor is placed on “brightness” using the up/down keys 27, 28, and the brightness level is determined by the cursor keys 29, 30. At this time, in response to the adjustment operation of the cursor keys 29, 30, a bar display 55 displayed in the “brightness” item changes, making it possible to visually confirm the brightness level. The display color is set as shown in FIG. 9, in a similar way to the brightness by placing the cursor on any one of “R”, “G”, and “B” using the up/down keys 27, 28 and setting the color level of each item by using the cursor keys 29, 30 while confirming the bar displays 56, 57, 58 of the items “R”, “G” and “B”.

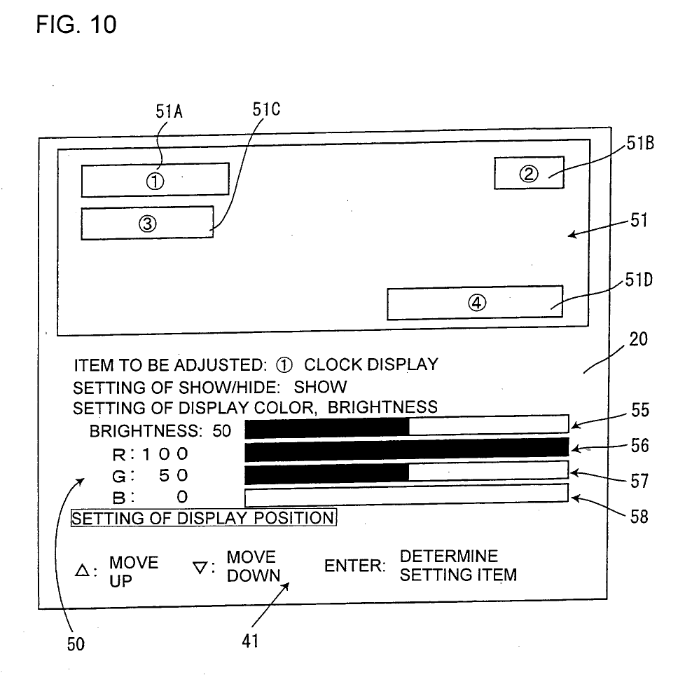

To set the display position of the on-screen display, as shown in FIG. 10, the cursor is placed on “setting of display position” using the up/down keys 27, 28, the item is determined by the enter key 33, and then, the display position of the display item is selected using the up/down keys 27, 28, and cursor keys 29, 30 is moved from right to left or up and down. This allows the selected display item, for example, the display position of the clock display 51A to be adjusted to an arbitrary position. As described above, the display position is preset to a predetermined position of the screen 20, and the clock display 51A is set at the top left side of the screen 20. This means that when the position is drastically moved, the number keys 26 of 1 to 9 are assigned to nine areas 60A to 60I. When the number key 26 of 1 is operated, the display position of the character is switched to the area 60A and when the number key 26 of 2 is operated, the display position of the character is switched to the area 60B, and when the number keys 26 of 3, 4, 5 are operated, the display position of the character is switched to area 60C, area 60D, area 60E sequentially. Therefore, pressing the number key 26 of 9 allows, for example, the display position of the initial clock display 51A to be moved to bottom right side of the screen 20 instantaneously. After this movement, it is possible to adjust the display position of the clock display 51A to an arbitrary position using the up/down keys 27, 28 and cursor keys 29, 30.

When items like the clock, channel, and operation displays such as play, stop, and fast-forward of the deck displayed on the screen 20 and each item of the counter display are set by operating the remote control device 9, the discrimination means 10 receives a transmission signal from the remote control device 9, and the instruction means 11 outputs a selection signal corresponding to each adjustment item to the OSD position control section 2, OSD color control section 3, and OSD brightness control section 4. The data of these OSD position control section 2, OSD color control section 3, and OSD brightness control section 4 is stored in the memory 5, of which the data stored in the memory 5 is fed back to the control sections 2 to 4, where the OSD display section 6 generates a character signal such as a number and character according to the data of the control sections 2 to 4, by which the character signal is output to the image signal processing circuit 7, superimposed on the image signal, and displayed on the display screen 20.

As shown above, when “clock display”, “channel display section”, “operation display”, and “counter display” are displayed on-screen and superimposed on an image signal, it is possible to set whether each item is to be displayed or not individually, display the display position of a character such as a character, number or symbol at an optimum position easily viewable to the user through the OSD position control section 2, change the display color of the character to an arbitrary display color through the OSD color control section 3 and change the display brightness through the OSD brightness control section 4, therefore it is possible to make the character displayed against the background image extremely easy to see.

Furthermore, when the display position of a character is changed, it is possible to instantaneously move the display position of the character to the areas 60A to 60I of the screen 20 assigned to the number keys 26 beforehand by operating the number keys 26 of the remote control device 9, so by adjusting the display position using the up/down keys 27, 28 and cursor keys 29, 30, it is possible to shorten the operation time and also simplify the movement operation even when the display position of a character is drastically moved.

As shown above, an embodiment of the present invention has been explained in detail, however, the present invention is not limited to the embodiment and can be implemented modified in various ways within the scopes of the present invention. For example, the display content of a character to be on-screen displayed, key array of the remote control device, and types of the keys can be selected as appropriate.

1. An on-screen display device which displays on-screen a character signal such as a number, character or symbol superimposed on an image signal on a screen, comprising:
display position control means for moving the display position of a character displayed on the screen to an arbitrary position; and
display color control means for changing the display color of the character.

2. The on-screen display device according to claim 1, further comprising brightness control means for changing the brightness level of the character displayed on the screen.

3. The on-screen display device according to claim 1 or 2, further comprising:
a remote control device which displays a selection menu on the screen when the display state of the character displayed on the screen is changed and outputs a remote control signal related to the selection operation;
discrimination means for discriminating a transmission signal from the remote control device; and
instruction means for receiving the transmission signal from the discrimination means and outputting a selection signal to the respective control means.

4. The on-screen display device according to claim 3, wherein the remote control device comprises key input means including a menu key and menu selection key for executing various adjustments/settings of electric apparatus, a plurality of number keys assigned so as to move the character to each of a plurality of areas preset on a screen when the display position of the character displayed on the screen is changed, and an adjustment operation key which adjusts the display position moved by this number key from right to left or up and down so as to move the display position to an arbitrary position.
